(19) United States
(12) Patent Application Publication
(10) Pub. No.: US 2022/0156461 A1
(43) Pub. Date: May 19, 2022

(54) A Method for Pre-Processing a Sequence of Words for Neural Machine Translation

(71) Applicant: Agency for Science, Technology and Research, Singapore (SG)

(72) Inventors: Zhong Wei Li, Singapore (SG); AI Ti AW, Singapore (SG)

(21) Appl. No.: 17/599,162

(22) PCT Filed: Mar. 27, 2020
(86) PCT No.: PCT/SG2020/050175

§ 371 Date: Sep. 28, 2021

(30) Foreign Application Priority Data
Mar. 28, 2019 (SG) 10201902819U

(51) Int. Cl. G06F 40/284; G06F 40/58; G06F 40/295

(52) U.S. Cl. CPC G06F 40/284; G06F 40/295; G06F 40/58

(57) ABSTRACT

This invention relates to a method and system for preparing a sequence of words according to a specific pre-process order before feeding the processed sequence of words to a Neural Machine Translation. The method comprises obtaining an input string, amending the input string to include named entities and boundary tags to the input string according to a pre-process order to form a processed string, and processing the processed input string using the NMT to convert the processed string into an alternative representation for the input string.

### FIELD OF INVENTION

This invention relates to a method and a system for Neural Machine Translation. Particularly, this invention relates to a method and a system that processes a sequence of words for Neural Machine Translation. More particularly, this invention relates to a method and a system that processes a sequence of words according to a specific pre-process order before feeding the processed sequence of words to a Neural Machine Translation.

### BACKGROUND

Neural machine translation (NMT) is a new approach to machine translation that uses a deep neural network such as recurrent neural network (RNN), convolutional neural network (CNN), Transformer and other known neural network to encode a source sentence into a vector, and uses another large network to generate sentence in the target language one word at a time using the source sentence embedding and attention mechanism.

NMT has achieved impressive result by learning the translation as an end-to-end model. Conventional NMT do not use linguistic features explicitly to train the model, which hopes that NMT can learn these sentence structures and linguistic features from sentence content with huge training data. However, because of the limitation of data distribution and model complexity, there is no guarantee that NMT can capture this information and make proper translation at all cases.

Thus, those skilled in the art are constantly striving to provide a method and a system that improves translation using NMT.

### SUMMARY OF INVENTION

The above and other problems are addressed and an advance in the state of the art is provided by a method and/or a system in accordance with this disclosure. A first advantage of a method and/or a system in accordance with embodiments of this disclosure is that it increases the accuracy of translation. A second advantage of a method and/or system in accordance with embodiments of this disclosure is that it is model independent and supports different types of model configurations (e.g. word-based and character-based source input. A third advantage of a method and/or system in accordance with embodiments of this disclosure is the application of method and/or system to any types of named entities including terminologies for domain-specific translation.

A first aspect of the disclosure relates to method performed by a computer for pre-processing a sequence of words for a neural machine translation (NMT). The method comprises: obtaining an input string; amending the input string to include named entities and boundary tags to the input string according to a pre-process order to form a processed string; and processing the processed string using the NMT to convert the processed string into an alternative representation for the input string.

In an embodiment of the first aspect of the disclosure, the step of amending the input string to include named entities and boundary tags to the input string according to the pre-process order to form the processed string comprises: tokenizing the input string to form a sequence of words; tagging named entities to each word in the sequence of words; splitting the sequence of words to form a plurality of word tokens; and combining the plurality of word tokens and named entities to form the processed string.

In an embodiment of the first aspect of the disclosure, the step of tagging named entities to each word in the sequence of words comprises: comparing each word in the sequence of words to a data structure to determine a corresponding named entity of each word; and tagging the corresponding named entities to each word.

In an embodiment of the first aspect of the disclosure, the step of splitting the sequence of words to form the plurality of word tokens further comprises: determining an out of vocabulary (OOV) word in each of the sequence of words, in response to determining the OOV word, splitting the OOV word into subword tokens using byte pair encoding; in response to determining a non-OOV word, the non-OOV word is taken as the word token; and adding subword connectors to each subword token other than the last subword token.

In an embodiment of the first aspect of the disclosure, the step of combining the plurality of word tokens and named entities to form the processed string comprises: aligning the word tokens and subword tokens with the corresponding named entities; generating word boundary tags (B,I,E) and adding the word boundary tags (B,I,E) between each of the word token and the corresponding named entities, where B is added to the first word token, E is added to the last word token, and I is added to tokens between the first and last word tokens; and generating subword boundary tags (B_, I_, E_) and adding subword boundary tags (B_, I_, E_) between the subword token and the corresponding named entities, where B_ is added to the first subword token, E_ is added to the last subword token, and I_ is added to subword tokens between the first and last subword tokens.

In an embodiment of the first aspect of the disclosure, the step of combining the plurality of word tokens and named entities to form the processed string comprises: aligning the word tokens with the corresponding named entities; and generating word boundary tags (B,I,E) and adding the word boundary tags (B,I,E) between each of the word token and the corresponding named entities, where B is added to the first word token, E is added to the last word token, and I is added to tokens between the first and last word tokens.

In an embodiment of the first aspect of the disclosure, the step of amending the input string to include named entities and boundary tags to the input string according to the pre-process order to form the processed string comprises: tokenizing the input string to form a sequence of words; tagging named entities to each word in the sequence of words; splitting the sequence of words to form a plurality of character tokens; and combining the plurality of character tokens and named entities to form the processed string.

In an embodiment of the first aspect of the disclosure, the step of combining the plurality of character tokens and named entities to form the processed string comprises: aligning the character tokens with the corresponding named entities; and generating boundary tags (B,I,E) and adding the boundary tags (B,I,E) between each of the character token and the corresponding named entities, where B is added to the first character token, E is added to the last character token, and I is added to character tokens between the first and last character tokens.

A second aspect of the disclosure relates to a processing system for pre-processing a sequence of words for a neural machine translation (NMT). The processing system comprising: a processor, a memory and instructions stored on the memory and executable by the processor to: obtain an input string; amend the input string to include named entities and boundary tags to the input string according to a pre-process order to form a processed string; and process the processed string using the NMT to convert the processed string into an alternative representation for the input string.

In an embodiment of the second aspect of the disclosure, the instruction to amend the input string to include named entities and boundary tags to the input string according to the pre-process order to form the processed string comprises instructions to: tokenize the input string to form a sequence of words; tag named entities to each word in the sequence of words; split the sequence of words to form a plurality of word tokens; and combine the plurality of tokens and named entities to form the processed string.

In an embodiment of the second aspect of the disclosure, the instruction to tag named entities to each word in the sequence of words comprises instructions to: compare each word in the sequence of words to a data structure to determine a corresponding named entity of each word; and tag the corresponding named entities to each word.

In an embodiment of the second aspect of the disclosure, the instruction to split the sequence of words to form the plurality of word tokens further comprises instructions to: determine an out of vocabulary (OOV) word in each of the sequence of words; in response to determining the OOV word, split the OOV word into subword tokens using byte pair encoding; in response to determining a non-OOV word, the non-OOV word is taken as the word token; and adding subword connectors to each subword token other than the last subword token.

In an embodiment of the second aspect of the disclosure, the instruction to combine the plurality of word tokens and named entities to form the processed string comprises: align the word tokens and subword tokens with the corresponding named entities; generate word boundary tags (B,I,E) and adding the word boundary tags (B,I,E) between each of the word token and the corresponding named entities, where B is added to the first word token, E is added to the last word token, and I is added to word tokens between the first and last word tokens; and generate subword boundary tags (B_, I_, E_) and adding subword boundary tags (B_, I_, E_) between the subword token and the corresponding named entities, where B_ is added to the first subword token, E_ is added to the last subword token, and I_ is added to subword tokens between the first and last subword tokens.

In an embodiment of the second aspect of the disclosure, the instruction to combine the plurality of word tokens and named entities to form the processed string comprises instructions to: align the word tokens with the corresponding named entities; and generate word boundary tags (B,I,E) and adding the word boundary tags (B,I,E) between each of the word token and the corresponding named entities, where B is added to the first word token, E is added to the last word token, and I is added to tokens between the first and last word tokens.

In an embodiment of the second aspect of the disclosure, the instruction to amend the input string to include named entities and boundary tags to the input string according to the pre-process order to form the processed string comprises instructions to: tokenize the input string to form a sequence of words; tag named entities to each word in the sequence of words; split the sequence of words to form a plurality of character tokens; and combine the plurality of character tokens and named entities to form the processed string.

In an embodiment of the second aspect of the disclosure, the instruction to combine the plurality of character tokens and named entities to form the processed string comprises instructions to: align the plurality of character tokens with the corresponding named entities; and generate boundary tags (B,I,E) and adding the boundary tags (B,I,E) between each of the character tokens and the corresponding named entities, where B is added to the first character token, E is added to the last character token, and I is added to character tokens between the first and last character tokens.

### BRIEF DESCRIPTION OF DRAWINGS

The above and other features and advantages of a method and a system in accordance with this invention are described in the following detailed description and are shown in the following drawings:

FIG. 1 illustrating a block diagram of an attention-based encoder-decoder neural network model;

FIG. 2 illustrating a process flow of a pre-process order to prepare the data to be fed to the attention-based encoder-decoder neural network model in accordance with an embodiment of this disclosure;

FIG. 3 illustrating the modules involved for executing the process flow as shown in FIG. 2 in accordance with an embodiment of this disclosure; and

FIG. 4 illustrating a diagram for Named Entities embedding input to single direction RNN.

### DETAILED DESCRIPTION

This invention relates to a method and a system for Neural Machine Translation. Particularly, this invention relates to a method and a system that processes a sequence of words for Neural Machine Translation. More particularly, this invention relates to a method and a system that processes a sequence of words according to a specific pre-process order before feeding the processed sequence of words to a Neural Machine Translation.

It is envisioned that a system and/or method in accordance with embodiments of this disclosure may be used to process a sequence of words according to a specific pre-process order before feeding the processed sequence of words to a Neural Machine Translation (NMT). Adding linguistic features to NMT has shown benefits to translation in many studies. In accordance with this disclosure, Named Entity features in source language are introduced to produce better word embedding. An experiment has been performed to show that by adding different Named Entity classes and boundary tags, Bilingual Evaluation Understudy (BLEU) increases by more than 1.0 point using a test set of 500 sentences with 3 references.

The potential benefit of explicitly encoding the linguistic features into NMT has been shown, where linguistic features (part-of-speech tag, lemmatized form and dependency label, morphology) is included at NMT source encoder side. Alternative approach incorporates syntactic information of target language as linearized, lexicalized constituency trees into NMT target decoder side. Results have shown that adding linguistic information at both source and target sides can be beneficial for NMT. Hence, it is desirous to incorporate named entities features to further improve NMT.

Named Entities (NE) play a crucial role in many monolingual and multilingual Natural Language Processing (NLP). Proper Named Entities identification will enhance sentence structure understanding for NMT, and hence will give better translation of the Named Entities and whole sentence.

Named Entities are hard to translate, as there are different types of Named Entity, e.g. Person, Place, Organization; logically there is different translation mechanism for different types of Named Entities. Unlike other words or phases of the sentence which are quite common in the training corpus, Named Entities expressions are quite flexible, they can compose any character or word and new named entities can be created any time, which is never see before. NMT needs to pay special attention for Named Entities to enhance the overall translation quality.

Named Entities are rare except for the famous named entities (Person, Location or Organization). Named Entities would consist of single word or several words, for any Named Entities Recognition system, it should identify the boundary of the named entity in the sentences, and perform translation as a single entity.

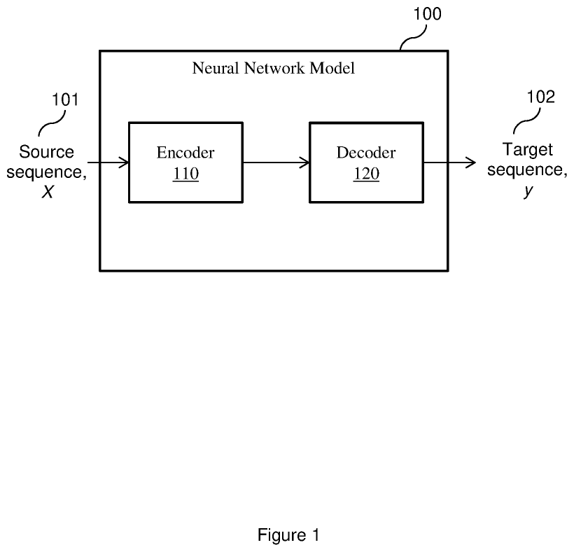

Machine Translation (MT) translates text sentence in source language to target language. Statistical machine translation systems use phrases as atomic units by training on large bilingual text corpora. Neural Machine Translation is a new approach where we train a single, large neural network to maximize the translation performance. For purposes of this disclosure, the proposed baseline system is based on attention-based encoder-decoder neural network model 100 as shown in FIG. 1.

The encoder 110, which is often implemented as a bidirectional recurrent network with long short-term memory (LSTM) units, first reads a source sentence 101 represented as a sequence of words, x=(x₁, x₂, . . . xₙ). The encoder 110 calculates a forward sequence of hidden states and a backward sequence of hidden states. These forwards and backwards hidden states are concatenated to obtain a sequence of hidden states as h=(h₁, h₂, . . . hₙ). Source sentence 101 may also be known as the original language.

The decoder 120 is implemented as a conditional recurrent language model that predicts a target sequence 102 represented as a sequence of words, y=(y₁, y₂, . . . yₘ), based on the source sequence 101, x=(x₁, x₂, . . . xₙ). Each word yᵢ is predicted based on the encoder hidden state Sᵢ, the previous word yᵢ₋₁, and a context vector cᵢ. cᵢ is a time-dependent context vector that is computed as a weighted-sum of the hidden states of h: cᵢ=Σⱼ a_{i,j} hⱼ. The weight a_{i,j} of each hidden state hⱼ is computed by the attention model which models the probability that yⱼ is aligned to xᵢ. Target sequence 102 may also be known as an alternative representation for the input sequence, i.e. in translated language. The details of attention-based encoder-decoder machine translation model 100 is known and hence omitted for brevity. For the purposes of this disclosure, we have implemented the embodiments of this invention based on OpenNMT PyTorch, an open-source neural machine translation system.

More importantly, the embodiments of this invention relates to the preparation of the source sequence 101. Specifically, named entities features are added to the source sequence 101. Besides raw word embedding, we generate named entities embedding to include named entity class and boundary information, thus the NMT 100 encoder 110 input, which is the source sequence 101, is a combination of raw word embedding, its corresponding named entities embedding and named entity boundary embedding.

The embodiments of this invention support both word-based and character-based NMT model. For Chinese to English translation, Chinese input can be segmented as word sequence or character sequence while English is normally word-based tokens. For word-based system, all unknown words are segmented as a sequence of sub words units using Byte Pair Encoding. For each word in source sequence 101, the named entities tags can be generated using any off-the-shelf or 3^{rd}-party tools. For example
Named Entities class tags for word: PERSON, ORGANIZATION, LOCATION, MISC, etc.)
Boundary tags for Named Entities (B, I, E) where B refers to beginning of the Named Entities, E refers to end of the Name Entities and I refers to intermediate tag which is between B and E.

We add the named entities class tags to the corresponding word sequence of the source sequence 101, and thus generate the factored input as shown in following example 1 below:

Original Source:

[symbol]

[symbol]

[symbol]

Word based input: [symbol] |O|O [symbol] |O|O [symbol] |B|PERSON [symbol] |O|O [symbol] |B|MISC [symbol] |O| [symbol] |O| [symbol] |O|, |O|

where Tag O means others. On adding the named entities, each identified word is compared to a data structure or a library to determine the corresponding named entity of each identified word. For example, the identified word “ [symbol] ” corresponds to PERSON in the data structure or library and the identified word “ [symbol] ” corresponds to MISC in the data structure or library. The identified words are spaced apart from each other by one spacing.

To generate character based input sequence for Chinese sentence, we split all word tokens as character tokens, and tag each character with the same tags of its corresponding word. Hence, with reference to the above example 1, the character based input would be as follows.

Character based input: [symbol] |O|O [symbol] |O|O [symbol] |O|O [symbol] |O|O [symbol] |B|PERSON [symbol] |I|PERSON [symbol] |E|PERSON [symbol] |O|O [symbol] |O|O [symbol] |B|MISC [symbol] |E|MISC [symbol] |O|O [symbol] |O|O [symbol] |O|O [symbol] |O|O [symbol] |O|O [symbol] |O|O [symbol] |O|O, |O|O

As observed above, if an identified word comprises 2 characters, boundary tag | will not be required. See above for “ [symbol] |B|MISC” which is split into “ [symbol] |B|MISC [symbol] |E|MISC”.

The details on the splitting and embedding of the Named Entities class tags for word and Boundary tags for Named Entities will now be described as follows.

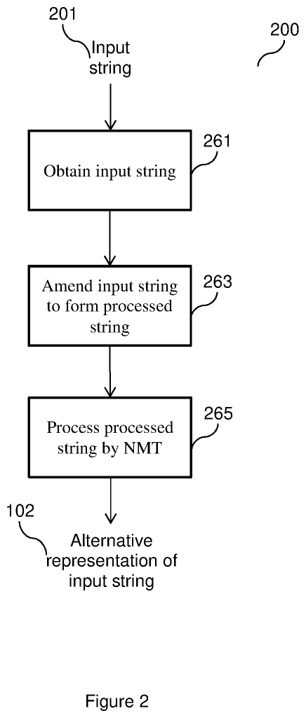

FIG. 2 illustrates a process flow 200 to process all the training data, development data, and testing data to generate the sequence for each source input sentence. The process flow 200 is essentially a pre-process order to prepare the source sequence 101. The process flow 200 begins with step 261 by obtaining an input string 201. In response to receiving the input string 201, process 200 amends the input string 201 to include named entities and boundary tags according to the pre-process order to form a processed string 202 in step 263. In step 265, process 200 processes the processed string 202 using an NMT to convert the processed string 202 into an alternative representation 102 for the input string 201.

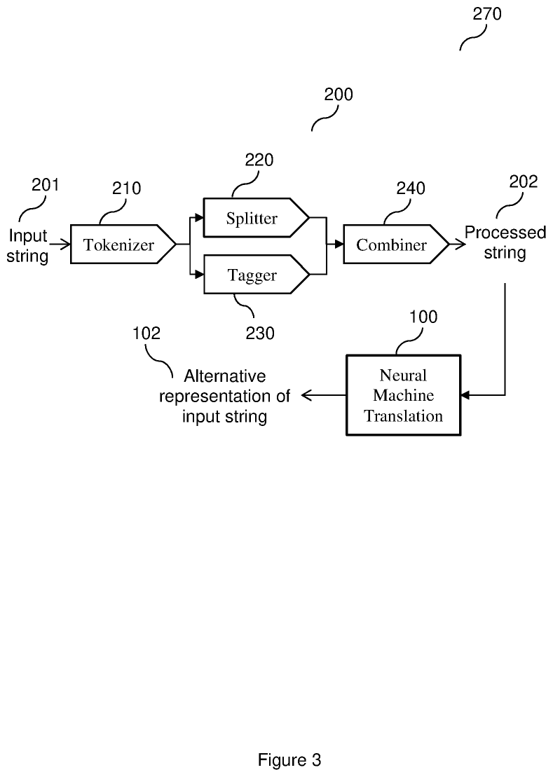

FIG. 3 illustrates the modules involved for executing the process flow 200. The modules comprise a tokenizer 210, a splitter 220, a tagger 230, a combiner 240 and an NMT 100. The tokenizer 210, splitter 220, tagger 230 and combiner 240 performs the step of 263 in process flow 200 and details of which will now be described as follows.

In response to receiving the input string 201, the tokenizer 210 tokenizes the input string 201 to a sequence of word tokens. The input string 201 is tokenized as a sequence of word or character tokens depending on the behavior of the tokenizer. Thereafter, the tokenized input sequence of word is forwarded to the splitter 220 and tagger 230. For brevity, the sequence of word tokens is also known as tokenized words.

In the tagger 230, it will identify and extract the named entities features for the character or word tokens. Specifically, the tagger 230 will compared the tokenized words which is a sequence of word tokens to a data structure or a library to determine the corresponding named entity of each character or word in the tokenized words. Corresponding named entities will then be tagged to each character or word in the tokenized words.

In the splitter 220, for word-based system, if the tokenized words are out of vocabulary words (OOV), it will split the tokenized words into sub-word tokens using byte pair encoding. If OOV is not available in the tokenized words, the tokenized words would be taken as the word tokens. For character tokens, we split each word as character sequence to form character token.

The combiner 240 will then receive the split word (i.e. word tokens, subword tokens and/or character tokens) from the splitter and extracted named entities feature with the relevant tagged and combine split word with the named entities feature with the relevant tagged with a boundary tag to form a processed sequence of words which is the source sequence 101 that is to be fed to the NMT 100 to determine an alternative representation of the input string 203, which is the target sequence 102. The combiner 240 aligns the character or word/subword tokens from character or subword splitter with their corresponding named entities classes to form the processed string 202. Named entities classes boundary tags (B,I,E) are generated at same time in the alignment process. See example 2 below on character based sequence and example 3 below on word-based sequence.

Example 2: character based sequence

Original Source: “ [symbol] ”

Tokenizer output: “ [symbol] ”

Tagger outputs: “ [symbol] |ORGANIZATION [symbol] |ORGANIZATION [symbol] |ORGANIZATION”

Splitter output: “ [symbol] ”

Combiner outputs: “ [symbol] B|ORGANIZATION [symbol] |I|ORGANIZATION [symbol] |I|ORGANIZATION [symbol] |I|ORGANIZATION [symbol] |I|ORGANIZATION [symbol] |I|ORGANIZATION [symbol] |E|ORGANIZATION”

In example 2 above, the original source is tokenized according to a sequence of word tokens. In this case, the tokenizer tokenized the original source into 3 tokenized words and they are: 1) [symbol] ; 2) [symbol] ; and 3) [symbol] . The 3 tokenized words are then tagged by the tagger 230 and split by the splitter 220.

In the tagger 230, each tokenized word is compared to a data structure or a library to determine the corresponding named entity of each tokenized word. For example 2, the 3 tokenized words correspond to ORGANIZATION.

In the splitter 220, the 3 tokenized words are split to individual character to form 7 character tokens. This can be observed by the spacing between each character token.

In the combiner 240, the character tokens from the splitter 220 are aligned with the corresponding named entities from the tagger. Boundary tags (B,I,E) are generated during the alignment process and added accordingly. Specifically, boundary tags (B,I,E) are generated and added between each of the character tokens and the corresponding named entities, where B is added to the first character token, E is added to the last character token, and I is added to character tokens between the first and last character tokens. For example 2, since the named entity for all 3 tokenized words is ORGANIZATION, B is added to the first character token [symbol] and ORGANIZATION and E is added between the last character token [symbol] and ORGANIZATION. Between the first and last character tokens which are [symbol] , I is added between each of these character tokens and ORGANIZATION.

Example 3: word based sequence

Original Source: “ [symbol] ”

Tokenizer output: “ [symbol] ”

Tagger outputs: “ [symbol] |ORGANIZATION [symbol] |ORGANIZATION [symbol] |ORGANIZATION”

Splitter output: “ [symbol] ”

Combiner outputs: “ [symbol] |B|ORGANIZATION [symbol] |I|ORGANIZATION [symbol] |E|ORGANIZATION”

In example 3 above, tokenizer 210 and tagger 230 remain the same as that shown in example 2. However, in the splitter 220, the 3 tokenized words are split if the tokenized word is an OOV word. In this example, the splitter 220 is unable to split further from each of the tokenized words as the 3 tokenized words are not OOV word. Hence, it can be observed that the splitter 220 outputs the 3 word tokens that correspond to the same 3 tokenized words.

In the combiner 240, the 3 word tokens from the splitter 220 are aligned with the corresponding named entities from the tagger 230. Boundary tags (B,I,E) are generated during the alignment process and added accordingly. Specifically, boundary tags (B,I,E) are generated and added between each of the 3 word tokens and the corresponding named entities where B is added to the first word token, E is added to the last word token, and I is added to word tokens between the first and last word tokens. For example 3, since the named entity for all 3 word tokens is ORGANIZATION, B is added to the first word token [symbol] and ORGANIZATION and E is added between the last word token [symbol] and ORGANIZATION. Between the first and last word tokens which is [symbol] , I is added between this word token and ORGANIZATION.

For word token that is an OOV word (e.g [symbol] in [symbol] ) it will be represented as a sequence of sub words where @@ represent sub words connector. For example, subword sequence of “ [symbol] @@ [symbol] @@ [symbol] ” is the representation of word “ [symbol] ”. In this case, we use special sub-word named-entity boundary tags (B_, I_, E_) for the subwords. See example 4 below for subword base sequence

Example 4: subword based sequence

Original Source: “ [symbol] ”

Tokenizer outputs: “ [symbol] ”

Tagger outputs: “ [symbol] |ORGANIZATION [symbol] |ORGANIZATION”

Splitter outputs: “ [symbol] @@ [symbol] @@ [symbol] ”

Combiner outputs: “ [symbol] |B|ORGANIZATION [symbol] @@|B_|ORGANIZATION [symbol] @@|I_|ORGANIZATION [symbol] |E_|ORGANIZATION”

In example 4 above, the original source is tokenized according to a sequence of word tokens. In this case, the tokenizer tokenized the original source to form the following sequence of word tokens and they are: 1) [symbol] ; and 2) [symbol] . Specifically, the sequence of word tokens contain 2 tokenized words. The 2 tokenized words are then tagged by the tagger 230 and split by the splitter 220.

In the tagger 230, each tokenized word is compared to a data structure or a library to determine the corresponding named entity of each tokenized word. For example 4, the 2 tokenized words correspond to ORGANIZATION.

In the splitter 220, the 2 tokenized words are split to form subword token if the word token is an OOV word. If the tokenized word is not an OOV word, the tokenized word would be taken as the word token. Specifically, the splitter 220 forms the word tokens and subword tokens in the following manner.

The splitter 220 determines whether each of the tokenized word is an OOV word. If a tokenized word is not an OOV word, that tokenized word will be a word token. If a tokenized word is an OOV word, that tokenized word will be split to form subword tokens and subword connectors are added to each subword token other than the last subword token. In this example, subword is not identified in “ [symbol] ” and subword is identified in “ [symbol] ” Hence, subword connectors @@ are added to “ [symbol] ” Specifically, @@ is added to each subword token other than the last subword token.

In the combiner 240, the word tokens and subword tokens from the splitter 220 are aligned with the corresponding named entities from the tagger 230. Boundary tags (B,I,E) for word tokens and (B_, I_, E_) for subword tokens are generated during the alignment process and added accordingly. Specifically, word boundary tags (B,I,E) are generated and added between each of the word tokens and the corresponding named entities, where B is added to the first word token, E is added to the last word token, and I is added to word tokens between the first and last word tokens. For subword tokens, the combiner 240 generates subword boundary tags (B_, I_, E_) and adds the subword boundary tags (B_, I_, E_) between the subword token and the corresponding named entities, where B_ is added to the first subword token, E_ is added to the last subword token, and I_ is added to subword tokens between the first and last subword tokens. For example 4, the first tokenized word is not an OOV while the second tokenized word is an OOV. Hence, the second tokenized word is further tokenized into subword tokens. Hence, B is added between the first word token [symbol] and ORGANIZATION. For the subword, B_ is added between the first subword token (in this case, a character) [symbol] @@ and ORGANIZATION and E_ is added to the last subword token [symbol] and ORGANIZATION. Between the first and last subword tokens which is [symbol] @@, I_ is added between this subword token and ORGANIZATION.

Essentially, the combiner 240 will combine each output from the splitter with each output of the tagger output with a boundary tag to form the processed string 202 which will be forwarded to the encoder 110 of the NMT 100. The NMT 100 will then process the processed string 202 to convert the processed string 202 into an alternative representation for the input string 201.

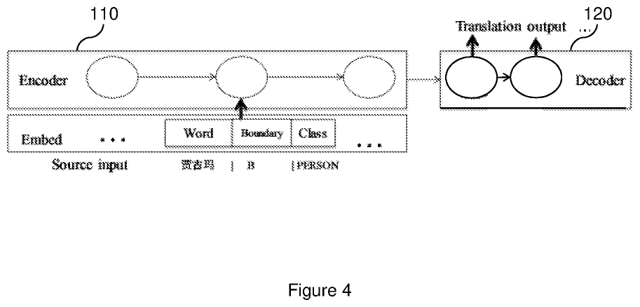

The encoder 110 can be single direction or bi-direction RNN. FIG. 4 shows the diagram for Named Entities embedding input to single direction RNN, the node at RNN can be LSTM or GRU.

Word Embeddings are dense vectors of real numbers, one per word in the vocabulary V_{w}; Word embeddings are stored as a |V_{w}|×D_{w} matrix, where |V_{w}| is the vocabulary size, and D_{w} is the dimensionality of the word embeddings. Similarly, we have |V_{b}|×D_{b} matrix for boundary embeddings, where |V_{b}| is the size of the named-entity boundaries and |V_{c}|×D_{c} matrix for named entities class embeddings, where |V_{c}| is the size of the named-entity class.

For each word in the input sequence, we look up separate embedding vectors for the corresponding word, boundary, and class embedding matrix. Then we concatenate the vectors as single vector to the input of encoder of NMT. The size of the concatenated embedding vectors is the dimension sum of D_{w}, D_{b}, D_{c}.

An evaluation has been conducted with the proposed pre-processing procedure on Chinese to English parallel corpus where we selected top 7 million Chinese-English sentence pairs from UNPCv1, and data from LDC and some proprietary data as the training corpus. After filtering out the long sentences (length >50), the total number of sentence pairs for training is around 6 million. Table 1 below shows the corpus sources for training, developing and test sets.

TABLE 1

| | | Number of | |
|---|---|---|---|
| Dataset | Corpus | sentence | Source/Content |
| Training | UNPCv1 | 7 millions | LDC |
| | LDC2017T05 | 200k | Chinese-forum.manual |
| | LDC2017T05 | | Broadcast-weblog.manual |
| | LDC2017T05 | | Commercial.manual.en |
| | Proprietary | | I2R |
| | data | | |
| Developing | Tune | 9088 | I2R |
| Testing | Test 1 | 977 | I2R |
| | Test 2 | 1445 | I2R |

Data Pre-Processing

For character based system, we split Chinese sentences as character based sequence, while English is word based sequence. To enable open vocabulary translation we used sub-words acquired through 60000 merge operations on the concatenation of the source and target side of the parallel training data.

Models Training

We build and train Chinese to English translation system based on OpenNMT PyTorch version: Open-Source Neural Machine Translation implementation based on PyTorch deep learning platform. We train the model with GPU:P40 from Nvidia. We use minibatches of size 64, a maximum sentence length of 50, word embeddings of size 500, boundary embeddings of size 5, NE class embeddings of size 10, hidden layers of size 1024, and we use a bidirectional encoder. We train the models with Adadelta and we apply dropout probability to 0.2 between LSTM stacks.

In the evaluation, we train both word based and character based models. We choose a best baseline model from the models without named entities tag at source sentences. We also choose another best model from the models with named entities tag at source sentences. We observed that the best baseline model without named entities tag is character-based model while the best model with named entities tag is word-based model.

Two test data set are used for the evaluation and Table 2 below shows the performance metrics:

TABLE 2

| | | Testing performance metrics | | | |
|---|---|---|---|---|---|
| Models | Test set | BLEU | NIST | TER | METEOR |
| Character based | Test 1 | 19.27 | 5.675 | 69.97 | 25.74 |
| | Test 2 | 14.11 | 4.878 | 77.18 | 22.35 |
| Character based with | Test 1 | 21.14 | 5.97 | 68.26 | 26.89 |
| Named Entity and Boundary | Test 2 | 15.48 | 5.17 | 74.12 | 23.21 |
| Tags | | | | | |
| Word based with Named | Test 1 | 21.42 | 6.046 | 66.93 | 26.97 |
| Entities and Boundary tags | Test 2 | 15.20 | 5.193 | 73.84 | 23.25 |

As shown in Table 2, we can see the performance improvement for all the performance metrics for the model with named entities and boundary tags compared with the best baseline model without named entities information. For BLEU result, there is 2.15 point improvement for Test 1 dataset, and 1.09 point improvement for Test 2 dataset. It shows that adding named entities features can significantly improve the performance of neural machine translation.

In this disclosure, a method to incorporate named entities features to improve neural machine translation is provided. Named entities embedding are added for each input sequence to the encoder of neural machine translation framework. The proposed method improves the overall translation accuracy of Chinese to English translation technology significantly, and the idea is language independent and applicable to other language pairs.

In summary, a method of pre-processing a source data (e.g. sequence of words, characters or text) for neural machine translation is introduced that extracts the named entities from the source language for translation, embeds linguistic features of the named entities, such as class tags and boundary tags into the source language, and combines the original source data with the corresponding named entities tagged data prior translation.

The method comprises: (1) tokenizing an original source into a sequence of word tokens (i.e. tokenized words), (2) extracting named entities features for each of the tokenized words; (3) segmenting out-of-vocabulary (OOV) or unknown words in any of the tokenized words as subword tokens using byte pair encoding; (4) assigning class and boundary information (or tags) to the character or word or sub-word tokens; (5) combining or concatenating the characters, words, or subwords from the segmented characters or words, with the corresponding named entities tags and boundary class to generate a factorized sequence of words for translation.

The above method is executable by a computing system which is a typical processing system such as a server computer, desktop computer, laptop computer, or other computer terminal. The computing system executes applications that perform the required processes in accordance with this disclosure. Processes are stored as instructions in a media that are executed by a processing system in computing system or a virtual machine running on the computing system to provide the method and/or system in accordance with this disclosure. The instructions may be stored as firmware, hardware, or software. The processing system may include Central Processing Unit (CPU) and/or Graphics Processing Unit (GPU) which is a processor, microprocessor, or any combination of processors and microprocessors that execute instructions to perform the processes in accordance with the present disclosure. CPU/GPU is communicatively connected to memory. Memory is a device that transmits and receives data to and from CPU/GPU for storing data to a media. Particularly, memory stores instructions, data and/or software instructions for processes such as the processes required for providing a method and system in accordance with this disclosure. The processing system also includes I/O device, keyboard, display, network device and any number of other peripheral devices communicatively connected to the CPU/GPU to exchange data for use in applications being executed by CPU/GPU. I/O device is any device that transmits and/or receives data from CPU/GPU. Keyboard is a specific type of I/O that receives user input and transmits the input to CPU/GPU. Display receives display data from CPU/GPU and display images on a screen for a user to see. Network device connects CPU/GPU to a network for transmission of data to and from other processing systems.

The above is a description of embodiments of a system in accordance with the disclosure as set forth below. It is envisioned that those skilled in the art can and will design alternative embodiments of this disclosure based upon this disclosure that infringe on this disclosure as set forth in the following claims.

1. A method performed by a computer for pre-processing a sequence of words for a neural machine translation (NMT), the method comprising:
obtaining an input string;
amending the input string to include named entities and boundary tags to the input string according to a pre-process order to form a processed string; and
processing the processed string using the NMT to convert the processed string into an alternative representation for the input string.

2. The method according to claim 2 wherein the step of amending the input string to include named entities and boundary tags to the input string according to the pre-process order to form the processed string comprises:
tokenizing the input string to form a sequence of words;
tagging named entities to each word in the sequence of words;
splitting the sequence of words to form a plurality of word tokens; and
combining the plurality of word tokens and named entities to form the processed string.

3. The method according to claim 2 wherein the step of tagging named entities to each word in the sequence of words comprises:
comparing each word in the sequence of words to a data structure to determine a corresponding named entity of each word; and
tagging the corresponding named entities to each word.

4. The method according to claim 3 wherein the step of splitting the sequence of words to form the plurality of word tokens further comprises:
determining an out of vocabulary (OOV) word in each of the sequence of words,
in response to determining the OOV word, splitting the OOV word into subword tokens using byte pair encoding;
in response to determining a non-OOV word, the non-OOV word is taken as the word token; and
adding subword connectors to each subword token other than the last subword token.

5. The method according to claim 4 wherein the step of combining the plurality of word tokens and named entities to form the processed string comprises:
aligning the word tokens and subword tokens with the corresponding named entities;
generating word boundary tags (B,I,E) and adding the word boundary tags (B,I,E) between each of the word token and the corresponding named entities, where B is added to the first word token, E is added to the last word token, and I is added to tokens between the first and last word tokens; and
generating subword boundary tags (B_, I_, E_) and adding subword boundary tags (B_, I_, E_) between the subword token and the corresponding named entities, where B_ is added to the first subword token, E_ is added to the last subword token, and I_ is added to subword tokens between the first and last subword tokens.

6. The method according to claim 3 wherein the step of combining the plurality of word tokens and named entities to form the processed string comprises:
aligning the word tokens with the corresponding named entities; and
generating word boundary tags (B,I,E) and adding the word boundary tags (B,I,E) between each of the word token and the corresponding named entities, where B is added to the first word token, E is added to the last word token, and I is added to tokens between the first and last word tokens.

7. The method according to claim 2 wherein the step of amending the input string to include named entities and boundary tags to the input string according to the pre-process order to form the processed string comprises:
tokenizing the input string to form a sequence of words;
tagging named entities to each word in the sequence of words;
splitting the sequence of words to form a plurality of character tokens; and
combining the plurality of character tokens and named entities to form the processed string.

8. The method according to claim 7 wherein the step of combining the plurality of character tokens and named entities to form the processed string comprises:
aligning the plurality of character tokens with the corresponding named entities; and
generating boundary tags (B,I,E) and adding the boundary tags (B,I,E) between each of the character tokens and the corresponding named entities, where B is added to the first character token, E is added to the last character token, and I is added to character tokens between the first and last character tokens.

9. A processing system for pre-processing a sequence of words for a neural machine translation (NMT), the processing system comprising:
a processor, a memory and instructions stored on the memory and executable by the processor to:
obtain an input string;
amend the input string to include named entities and boundary tags to the input string according to a pre-process order to form a processed string; and
process the processed string using the NMT to convert the processed string into an alternative representation for the input string.

10. The processing system according to claim 9 wherein the instruction to amend the input string to include named entities and boundary tags to the input string according to the pre-process order to form the processed string comprises instructions to:
tokenize the input string to form a sequence of words;
tag named entities to each word in the sequence of words;
split the sequence of words to form a plurality of word tokens; and
combine the plurality of word tokens and named entities to form the processed string.

11. The processing system according to claim 10 wherein the instruction to tag named entities to each word in the sequence of words comprises instructions to:
compare each word in the sequence of words to a data structure to determine a corresponding named entity of each word; and
tag the corresponding named entities to each word.

12. The processing system according to claim 11 wherein the instruction to split the sequence of words to form the plurality of word tokens further comprises instructions to:
determine an out of vocabulary (OOV) word in each of the sequence of words;
in response to determining the OOV word, split the OOV word into subword tokens using byte pair encoding;
in response to determining a non-OOV word, the non-OOV word is taken as the word token; and
add subword connectors to each subword token other than the last subword token.

13. The processing system according to claim 12 wherein the instruction to combine the plurality of word tokens and named entities to form the processed string comprises:
align the word tokens and subword tokens with the corresponding named entities;
generate word boundary tags (B,I,E) and adding the word boundary tags (B,I,E) between each of the word token and the corresponding named entities, where B is added to the first word token, E is added to the last word token, and I is added to tokens between the first and last word tokens; and
generate subword boundary tags (B_, I_, E_) and adding subword boundary tags (B_, I_, E_) between the subword token and the corresponding named entities, where B_ is added to the first subword token, E_ is added to the last subword token, and I_ is added to subword tokens between the first and last subword tokens.

14. The processing system according to claim 12 wherein the instruction to combine the plurality of word tokens and named entities to form the processed string comprises instructions to:
align the word tokens with the corresponding named entities;
generate word boundary tags (B,I,E) and adding the word boundary tags (B,I,E) between each of the word token and the corresponding named entities, where B is added to the first word token, E is added to the last word token, and I is added to tokens between the first and last word tokens.

15. The processing system according to claim 11 wherein the instruction to amend the input string to include named entities and boundary tags to the input string according to the pre-process order to form the processed string comprises instructions to:
tokenize the input string to form a sequence of words;
tag named entities to each character in the sequence of words;
split the sequence of words to form a plurality of character tokens; and
combine the plurality of character tokens and named entities to form the processed string.

16. The processing system according to claim 15 wherein the instruction to combine the plurality of character tokens and named entities to form the processed string comprises instructions to:
align the plurality of character tokens with the corresponding named entities; and
generate boundary tags (B,I,E) and adding the boundary tags (B,I,E) between each of the character tokens and the corresponding named entities, where B is added to the first character token, E is added to the last character token, and I is added to character tokens between the first and last character tokens.
